(19) United States
(12) Patent Application Publication
(10) Pub. No.: US 2021/0084874 A1
(43) Pub. Date: Mar. 25, 2021

(54) FISHING LURE WITH PROTECTIVE FEATURE

(71) Applicant: Robert R. Rauch, Chanhassen, MN (US)

(72) Inventor: Robert R. Rauch, Chanhassen, MN (US)

(21) Appl. No.: 16/843,381

(22) Filed: Apr. 8, 2020

Related U.S. Application Data
(60) Provisional application No. 62/830,557, filed on Apr. 8, 2019.

(51) Int. Cl. A01K 85/00

(52) U.S. Cl. CPC A01K 85/00; B29C 45/14336

(57) ABSTRACT

A layer of softer plastic, relative to a plastic lure body, is affixed to the lure at either a lip portion, at least one side of the lure body or both the lip portion and the at least one side to protect the functionality and appearance of the lure and to act as a bumper.

### CROSS REFERENCE TO RELATED APPLICATIONS

This application claims the benefit of U.S. Provisional Application No. 62/830,557 filed Apr. 8, 2019 entitled FISHING LURE WITH PROTECTIVE FEATURE.

### BACKGROUND OF THE INVENTION

Hard plastic artificial lures are a popular replacement for live bait, and are used regularly by anglers to catch a wide variety of fresh water and salt water sport fish. One of the most popular categories of hard plastic artificial lures are crank baits which are generally in the shape of a minnow or bait fish. Anglers use these crank baits in all depths of the water column and like to bounce these lures off of a structure (i.e., sunken logs, timber or rocks) to get the fish's attention and entice them to bite the lure. In the process of doing this, the crank baits frequently get damaged on the lip or the side of the lure. It would therefore be desirable to have a protective feature or features incorporated into the lure construction which serves to inhibit or prevent the above described damage caused by such impacts with environmental structures.

### SUMMARY OF THE INVENTION

Briefly stated, the invention uses over-molding, or other suitable application technique, to add a layer of softer plastic relative to the hard plastic body, for example silicone rubber or other elastomer, to the lure at a lip portion or at least one side/bottom, or both the lip and the at least one side/bottom to protect the functionality and appearance of the lure and to act as a bumper.

The above, and other objects, features and advantages of the present invention will become apparent from the following description read in conjunction with the accompanying drawing.

### BRIEF DESCRIPTION OF THE DRAWING

FIG. 1 depicts a typical hard plastic crank bait of conventional design;

FIG. 2 depicts an embodiment of a crank bait with a feature according to the invention protecting a lip portion of the lure;

FIG. 3 depicts another embodiment of a crank bait with a feature according to the invention protecting at least one side of the lure; and

FIG. 4 depicts yet another embodiment of a crank bait with a feature according to the invention protecting both the lip portion and the at least one side of the lure.

### DETAILED DESCRIPTION OF THE PREFERRED EMBODIMENT

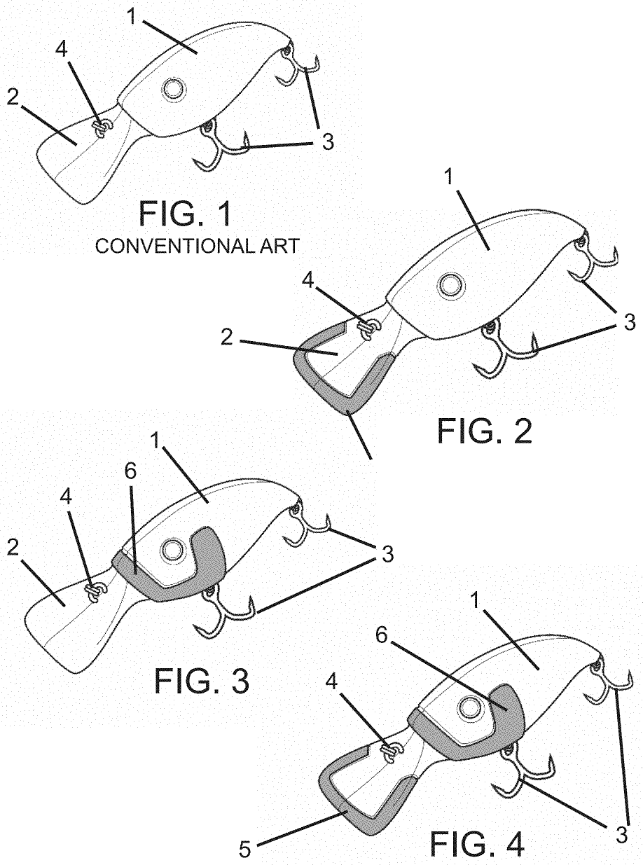

Referring to the figures, FIG. 1 shows a hard-bodied lure of conventional construction, identified generally at 10. Lure 10 comprises a lure body 1, a lip portion 2, hooks 3 and a line fastening portion 4 for attaching a fishing line to lure 10. A first embodiment of a lure 20 is depicted in FIG. 2, and includes the elements identified above. In addition, in accordance with the invention, a relatively softer, advantageously resilient material, is applied lip portion 2, conveniently by overmolding, as an impact shield 5, serving to protect lip portion 2 against impact damage.

A second embodiment of a lure according to the invention, is shown in FIG. 3 at 20′, and includes an impact shield 6, comprised of like material to that of impact shield 5 in the previously described first embodiment, adhered thereto in a like manner, serving to protect at least one side and/or an underside 15 against impact damage from contact with underwater environmental structures. A third embodiment, depicted as lure 29″, combines the features of the first and second embodiments, and incorporates both impact shield 5 on lip portion 2 and impact shield 6 on at least one side and/or an underside of lure body 1.

It is noted that, while lure body 1 is described by example as comprising a hard plastic, such as, for example, ABS, it can be any suitable material, such as for example, wood, metal, etc., without departure from the invention. Similarly lip portion 2 can also be comprised of any suitable material, such as, for example, the same material as the lure body 1 or metal, etc.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A fishing lure, comprising:
a plastic lure body;
a lip portion carried on said lure body to which a fishing line is attachable; and
a layer of an other plastic comprised of a protective material which is relatively softer than the plastic lure body, the layer being affixed to at least one of said lip portion or at least one side or bottom of the lure body.

2. A fishing lure according to claim 1, wherein said protective material comprises a silicone rubber.

3. A fishing lure according to claim 1, wherein said layer comprises an overmolded deposit of said protective material.

4. A method of protecting a fishing lure against damage caused by contact with a submerged structure, the fishing lure having a lure body comprised of a first material and a lip portion carried on the lure body, the method comprising:
applying a layer comprised of a second material which is relatively softer than at least one of the first material or the lip portion to at least one of the lip portion or at least one side or bottom of the lure body.

5. A method of supplying a fishing lure which includes a feature inhibiting damage, the fishing lure including a lure body and a lip portion carried thereon, the method comprising:
providing the fishing lure with a layer comprised of a material which is relatively softer than at least one of the lip portion or the lure body, including affixing the layer to at least one of the lip portion or at least one side or bottom of the lure body; and
marketing the fishing lure as being effective for inhibiting damage thereto resulting from an impact with a submerged structure.
